(19) United States
(12) Patent Application Publication
(10) Pub. No.: US 2026/0262627 A1
(43) Pub. Date: Sep. 10, 2026

(54) HEIGHT GUIDE FOR A CUTTING SYSTEM, CUTTING SYSTEM AND METHOD FOR GUIDING THE HEIGHT OF SUCH A CUTTING SYSTEM

(71) Applicant: Zürn Harvesting GmbH & Co. KG, Schöntal-Westernhausen (DE)

(72) Inventors: Martin STAHL, Boxberg-Schwabhausen (DE); Rolf ZURN, Schöntal-Westernhausen (DE)

(21) Appl. No.: 19/127,295

(22) PCT Filed: Nov. 7, 2023
(86) PCT No.: PCT/EP2023/081043

§ 371 Date: May 5, 2025

(30) Foreign Application Priority Data
Nov. 7, 2022 (DE) 10 2022 129 369.6

(51) Int. Cl. A01M 21/02

(52) U.S. Cl. CPC A01M 21/02

(57) ABSTRACT

A height guide for a cutting system for field hygiene includes a sensor system to determine a vegetation stand of a field, and an evaluation unit coupled to the sensor system. The evaluation unit analyzes the vegetation stand and determines a target cutting plane that lies at the level of the upper edge of a crop stand. The upper edge of the crop stand lies below an upper edge of the entire vegetation stand.

### CROSS-REFERENCE TO RELATED APPLICATIONS

This application is a U.S. National Stage Application of International Application No. PCT/EP2023/081043, filed on Nov. 7, 2023, which claims priority to European Patent Application No. 10 2022 129 369.6, which was filed on Nov. 7, 2022, the contents of each of which are hereby incorporated by reference.

### BACKGROUND

### Technical Field

The present disclosure relates to a height guide for a cutting system for field hygiene, in particular for a weed cutter and/or a weed seed collection unit, to a cutting system, in particular a weed cutter and/or a weed seed collection unit, comprising such a height guide, and to a corresponding method for height guidance.

### Background Information

In agriculture, it regularly happens that a stand of weeds grows over the upper edge of a crop stand. This overhang then shades the crop stand and inhibits its development or growth.

Conventional height guides are not able to determine a target cutting plane that lies at the level of the upper edge of a crop stand if there is a corresponding overhang of weeds and the upper edge of the entire vegetation stand thus lies above the upper edge of the crop stand. However, such a determination is necessary to appropriately control a cutting system for field hygiene, in particular for a weed cutter and/or a weed seed collection unit, to remove the weed overhang.

A conventional apparatus for merely determining the height of the entire vegetation stand is, for example, known from U.S. Pat. No 10,837,758 B2.

### SUMMARY

Against the background of the problem described above, it is an object of the present disclosure to provide a height guide, a cutting system and a method that enable a reliable removal of the weed overhang on a field.

This object is satisfied by the subject matter disclose herein. Advantageous further developments of the disclosure can be also seen from the present disclosure.

According to a first aspect of the present disclosure, a height guide for a cutting system for field hygiene, in particular for a weed cutter and/or a weed seed collection unit, comprises a sensor system for determining a vegetation stand of a field and an evaluation unit that is coupled to the sensor system. The evaluation unit is configured to analyze the determined vegetation stand and to determine a target cutting plane that lies at the level of the upper edge of a crop stand. In this respect, the target cutting plane lies below an upper edge of the entire vegetation stand.

In other words, the evaluation unit is configured to determine an upper edge of the crop stand that lies below the upper edge of the entire vegetation stand, and thus to determine the position of the target cutting plane. If the cutting plane of the cutting system is then set in accordance with the target cutting plane, an overhang of weeds projecting over the upper edge of the crop stand can be reliably cut off using the cutting system and can be collected, if necessary. A stand of weeds in the area of the stem region of the crop plants up to the upper edge of the crop stand itself remains unaffected in this respect.

With respect to the determination of the vegetation stand, it should be noted that, according to the disclosure, it is not necessary to completely determine and analyze the entirety of the vegetation stand. Depending on the specific design of the evaluation unit, the weed stand in the stem region of the crop plants can, for example, be disregarded when determining the vegetation stand. On the other hand, a ground plane of the field can also be used to determine the vegetation stand.

What is important for the present disclosure is that the data from the determination of the vegetation stand enable the evaluation unit to determine the target cutting plane for removing the weed overhang. Which data are in this respect specifically used with respect to the vegetation stand depends on the respective vegetation situation.

The sensor system preferably comprises at least one contactless sensor.

Contactless is here understood as a sensor that does not perform any mechanical sensing. Contactless sensors have the advantage of being less susceptible to wear and usually provide a more comprehensive or more complete overall picture of the respective vegetation stand.

The sensor system preferably only comprises contactless sensors.

The complete elimination of mechanical contact sensors enables a more efficient design of the sensor system and the increase of the service life.

The sensor system preferably comprises at least one of the following sensors: an optical sensor, in particular a 2D camera, a 3D camera, a stereo camera and/or a multispectral camera; a laser sensor; a LiDAR (light detection and ranging) sensor; an acoustic sensor, in particular an ultrasonic sensor; and/or a radar sensor.

The sensors listed have proven to be particularly suitable for determining the vegetation stand of a field. They in particular allow the vegetation stand of the field to be mapped in sufficient detail without wear.

The sensor system preferably comprises at least two sensors and the evaluation unit is configured to determine and/or to verify the target cutting plane based on the signals of at least two of these sensors.

In this respect, the at least two sensors can both be sensors with different designs or modes of operation and at least two sensors that are similar or even identical to one another. Within the meaning of the present disclosure, it is in this respect only important that each of the sensors maps the region in which the corresponding vegetation stand is to be determined. In particular, the different sensors in this respect also provide different data about the corresponding region. The different data can in this respect result from a different technical or functional design of the respective sensors or only from a different positioning and orientation of the respective sensors.

According to one embodiment of the disclosure, the evaluation unit can be configured to determine the target cutting plane using a first set of sensors and to verify the target cutting plane using a second set of sensors that in particular comprises sensors that are not also assigned to the first set of sensors. This enables an even more precise and reliable determination of the target cutting plane and thus an optimization of the height guide of the cutting system.

The sensor system preferably has a 3D stereo camera and the evaluation unit is configured to determine the target cutting plane by an evaluation of a 3D point cloud obtained above the target cutting plane.

In tests, such 3D stereo cameras have proven to be particularly suitable for determining the position of the target cutting plane at the level of the upper edge of the crop stand in a particularly reliable and accurate manner.

The sensor system preferably comprises an ultrasonic or radar sensor and the evaluation unit is configured to verify an already determined target cutting plane based on the output of the ultrasonic or radar sensor.

Corresponding ultrasonic and radar sensors are both comparatively inexpensive and durable, yet have proven to be suitable for verifying the position of the target cutting plane.

The evaluation unit is preferably configured to determine the upper edge of the entire vegetation stand and/or an upper edge of a weed stand in the stem region of the crop stand and/or the ground plane.

Aa a result, in particular the upper edge of the entire vegetation stand, i.e. the entirety of the crop stand and the weed stand, and/or the ground plane can act as a reference point for the determination of the upper edge of the crop stand, and thus of the target cutting plane, and for the setting of the cutting system to the target cutting plane. The upper edge of the weed stand in the stem region can provide further valuable information about the entire vegetation stand.

In this respect, the evaluation unit is preferably configured to determine the target cutting plane via a positive height with respect to the ground plane or via a negative height with respect to the upper edge of the entire vegetation stand.

The definition of the target cutting plane via the positive height with respect to the ground plane enables a particularly accurate and precise control of the cutting system, in particular with ground-based cutting systems, a low crop stand and/or a high weed overhang. The definition of the target cutting plane via the negative height with respect to the upper edge of the entire vegetation stand enables a particularly accurate and precise control of the cutting system, in particular with flying cutting systems, a high crop stand and/or a low weed overhang.

The evaluation unit is preferably coupled or can be coupled to at least one output unit that outputs a signal that indicates the position of the target cutting plane.

Such an output unit enables the simple and expedient transmission of the information on the position of the target cutting plane to the corresponding height guide of the cutting system.

The output unit preferably comprises an optical display, in particular in the form of a screen or an LED display, that informs a user of the cutting system about the position of the determined target cutting plane.

This easily makes it possible for a user of the cutting system to perform the manual setting of the cutting plane of the cutting system in accordance with the determined target cutting plane.

Alternatively or additionally thereto, the output unit is configured to be coupled to a control unit of the cutting system and to output a control signal to the control unit, the control signal setting a cutting plane of the cutting system in accordance with the determined target cutting plane.

This enables a fully automatic setting of the cutting plane of the cutting system. Due to a visual display provided in parallel thereto for the user, the user can once again check and, if necessary, manually adjust the automatically performed setting of the cutting plane.

According to a second aspect of the present disclosure, a cutting system for field hygiene, in particular in the form of a weed cutter and/or a weed seed collection unit, comprises a cutting unit for trimming the vegetation of a field, a control unit for setting a cutting plane of the cutting system, and one of the above-described height guides.

This makes it possible to obtain a cutting system that can remove a weed overhang in a reliable and accurate manner.

According to a third aspect of the present disclosure, a method for the height guidance of a cutting system for field hygiene, in particular of the cutting system described above, comprises the following steps: determining a vegetation stand of a field by a sensor system; analyzing the determined vegetation stand by an evaluation unit; automatically determining a target cutting plane that lies at the level of an upper edge of a crop stand, the upper edge of a crop stand itself lying below an upper edge of the entire vegetation stand; and setting a cutting plane of the cutting system in accordance with the determined target cutting plane.

The determination of the target cutting plane, which indicates the upper edge of the crop stand, by the above-mentioned method enables the reliable and accurate removal of the weed overhang already described above. Conventional methods are not able to determine a corresponding target cutting plane at the level of the upper edge of the crop stand if a weed overhang is present.

The determination of the vegetation stand preferably takes place substantially, in particular completely, in a contactless manner.

Corresponding contactless sensors are used for this purpose. This enables a particularly efficient determination of the target cutting plane and the reduction or even avoidance of wear in the corresponding system.

The upper edge of the entire vegetation stand, an upper edge of a weed stand in the stem region of the crop stand and/or the ground plane are preferably also determined and are in particular considered when setting the cutting plane.

As already presented above, in particular the upper edge of the entire vegetation stand, i.e. the entirety of the crop stand and the weed stand, and/or the ground plane can act as a reference point for the determination of the upper edge of the crop stand, and thus of the target cutting plane, and for the setting of the cutting system to the target cutting plane. The upper edge of the weed stand can provide further valuable information about the entire vegetation stand.

The target cutting plane is preferably determined via a positive height with respect to the ground plane or via a negative height with respect to the upper edge of the entire vegetation stand.

As already presented above, the definition of the target cutting plane via the positive height with respect to the ground plane enables a particularly accurate and precise control of the cutting system, in particular with ground-based cutting systems, a low crop stand and/or a high weed overhang. The definition of the target cutting plane via the negative height with respect to the upper edge of the entire vegetation stand enables a particularly accurate and precise control of the cutting system, in particular with flying cutting systems, a high crop stand and/or a low weed overhang.

### BRIEF DESCRIPTION OF THE DRAWINGS

The disclosure will be described in the following by way of example with reference to the enclosed drawings. There are shown

FIG. 1 is a first example of a vegetation stand of a field in which the use of a system or method according to the disclosure is possible and useful;

FIG. 2 is a second example of a vegetation stand of a field in which the use of a system or method according to the disclosure is possible and useful;

FIG. 3 is a third example of a vegetation stand of a field in which the use of a system or method according to the disclosure is possible and useful;

FIG. 4 a schematic example of the mode of operation of a system according to the disclosure;

FIG. 5 an example of data that indicate a vegetation stand of a field; and

FIG. 6 a recording of a field section to be processed with the target cutting plane determined.

### DETAILED DESCRIPTION

The present disclosure serves for the height guidance of a cutting system for removing a weed overhang a that projects over an upper edge of the crop stand b of a field. Unlike shown, the overhang can also be uneven in this respect.

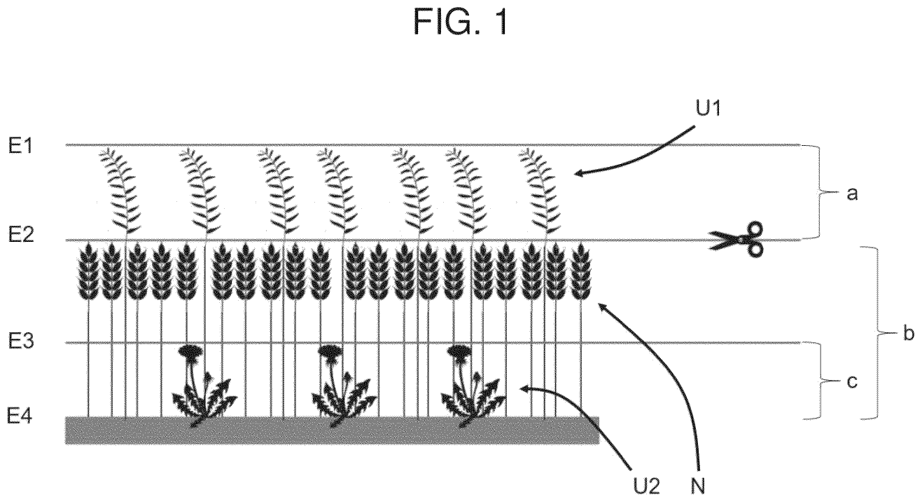

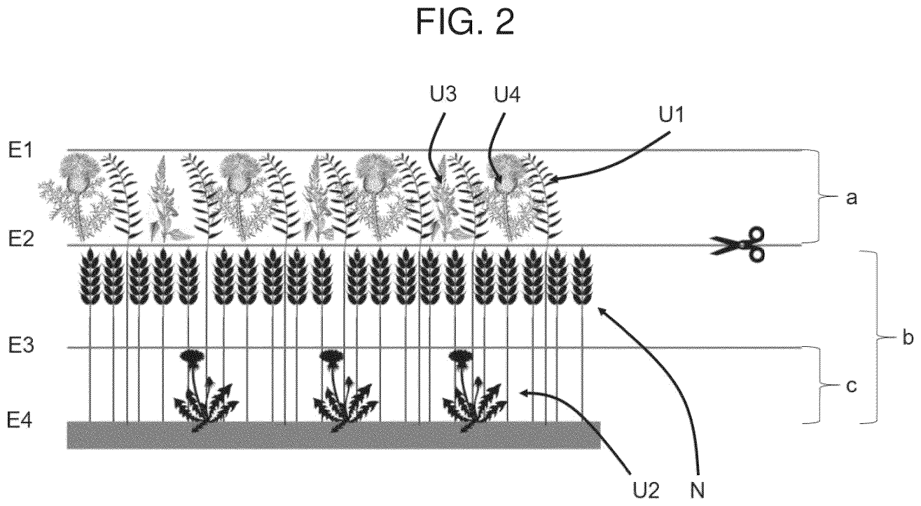

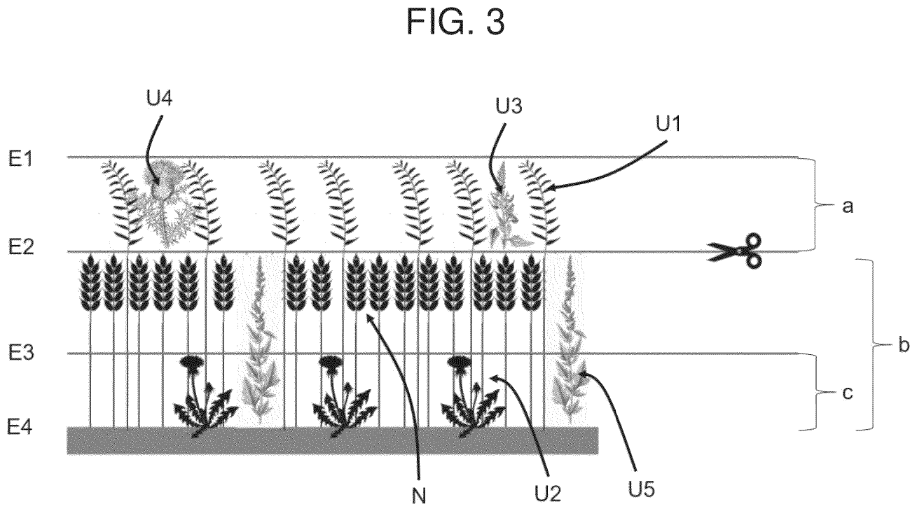

It is not relevant whether there is also a weed stand c in the stem region of the crop stand b (cf. FIGS. 1 to 3) or a weed stand that only reaches up to the upper edge E2 of the crop stand (cf. FIG. 3). According to the disclosure, it is not relevant either whether the weed overhang a is sparse (cf. FIG. 1), is dense (cf. FIG. 2) or is uneven (cf. FIG. 3). In this respect, the composition of the weed overhang a can be homogeneous (cf. FIG. 1) or heterogeneous (cf. FIGS. 2 and 3). Only the presence of a weed overhang a (at least in some regions) in the first place is necessary for the use of the present disclosure.

In FIGS. 1 to 4, plane E1 indicates the upper edge of the entire vegetation stand a, b and c, plane E2 corresponds to the target cutting plane determined according to the disclosure at the level of the upper edge of the crop stand, plane E3 indicates the upper edge of a weed stand in the stem region of the crop stand, and plane E4 indicates the ground plane. In this respect, one and the same kind of crop plants N is shown graphically in each case. However, the use of the present disclosure is not limited to a single kind of crop plants N, and particularly not to the kind of crop plants N shown. The Figures also show five different kinds of weeds U1, U2, U3, U4 and U5. However, the use of the present disclosure is not limited to only 2 to 5 different kinds of weeds U1 to U5, and is particularly not limited to the kinds of weeds U1 to U5 shown.

The disclosure is based on the realization that a mechanical removal of a weed stand a projecting over the crop stand b by a mechanical cutting system can make a significant contribution to field hygiene. This was previously not possible since known systems were not able to determine the upper edge E2 of the crop stand b if it lies below an upper edge E1 of the entire vegetation stand a, b and c.

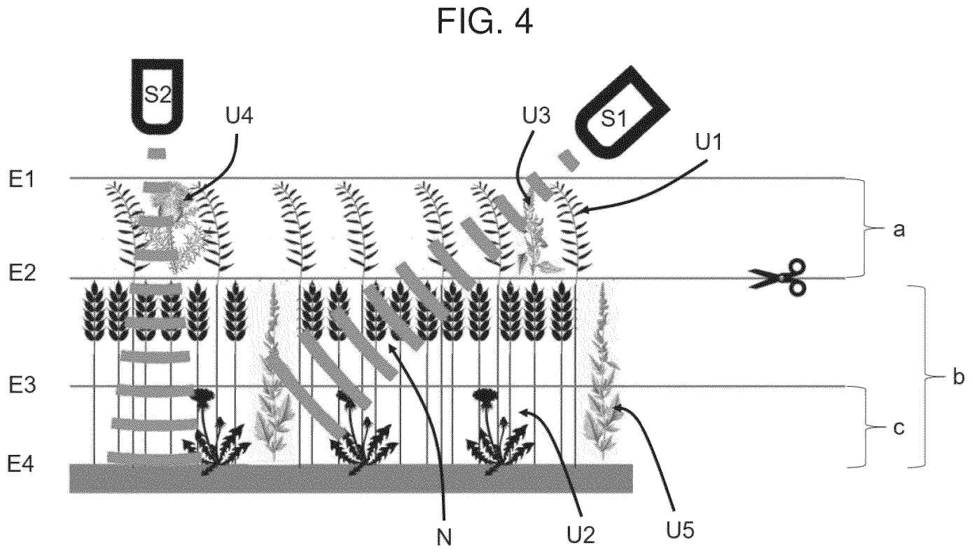

As shown in FIG. 4, the present disclosure proposes the determination of the target cutting plane E2 by a corresponding sensor system S1 and S2 and an associated evaluation unit. The determination of this target cutting plane E2, which lies above the ground plane E4, above the upper edge E3 of a weed stand c in the stem region of the crop stand b and below the upper edge E1 of the entire vegetation stand a, b and c, is a prerequisite for the field hygiene improved according to the disclosure.

Due to the reliable and accurate determination of this intermediate plane E2, the weed overhang a can be accurately removed using a mechanical cutting system. In this respect, the removed weeds and in particular the weed seeds included therein can be collected directly. Thus, the weeds can be prevented from being sown again by falling seeds. Since, today, many of the common weeds are resistant with respect to the usual chemical and/or biological weedkillers, the mechanical removal of the respective overhang a is a suitable way to control these resistant weeds. Furthermore, the mechanical control of the weeds is more environmentally friendly and complies with organic farming and water conservation regulations in this respect.

To determine the respective target cutting plane, an evaluation unit of the height guide uses a sensor system S1 and S2 that determines the vegetation stand a, b and c of the respective field. In this respect, the sensor systems S1 and S2 in particular each determine the vegetation stand a, b and c in a specific region of the field in front of the corresponding cutting system while the cutting system is moving across the field.

The corresponding sensor system comprises at least two sensors S1 and S2 for a particularly reliable determination of the vegetation stand a, b and c. The evaluation unit is in this respect configured to determine the position of the target cutting plane E2 based on the signals of a first set of these sensors S1 and S2.

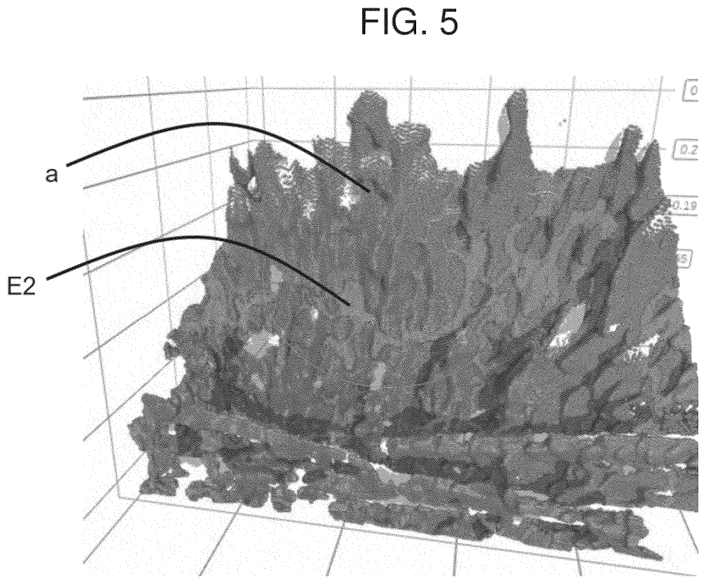

In the exemplary case of a 3D stereo camera S1 as the sensor of such a sensor system, an image of the vegetation stand a, b and c is recorded by the sensor S1. In the evaluation unit, the image (or the images) obtained from the 3D stereo camera S1 is converted into a 3D point cloud. A graphical representation of such a 3D point cloud is shown in FIG. 5, for example.

The evaluation unit is configured to analyze this image using standard graphical analysis methods and to identify the target cutting plane E2 that indicates the upper edge of the crop stand b. In this respect, the weed stand in particular projects unevenly over the upper edge E2 of the crop stand b and thus over the determined target cutting plane E2.

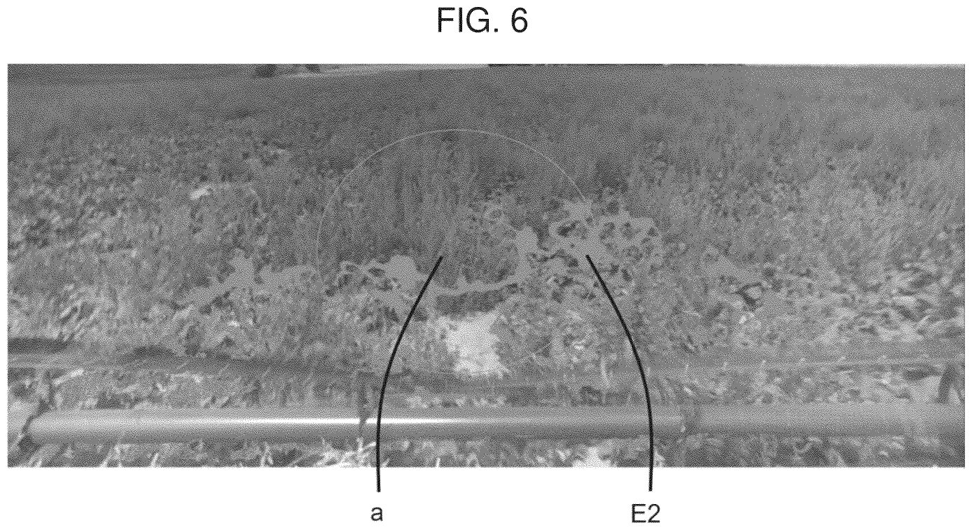

FIG. 6 shows a photo of the field from the point of view of the cutting system with the determined and virtually added target cutting plane E2, which indicates the upper edge of the crop stand b, and with the weed overhang a to be removed. If the cutting plane of the cutting system is now set to the height of the target cutting plane E2, the weed overhang a can be removed in a reliable and accurate manner by the cutting system.

For an even more reliable precise determination of the position of the target cutting plane E2, the evaluation unit can further be configured to verify the position of the target cutting plane E2 based on the signals of a second set of sensors S2 that differs from the first set of sensors S1.

In this respect, the second set of sensors S2 in particular includes a different kind of sensors than were used to originally determine the target cutting plane E2. If, as in the present embodiment example, a 3D stereo camera S1 is used as the sensor for determining the target cutting plane E2, an ultrasonic or radar sensor S2 is, for example, suitable for verifying the target cutting plane E2.

However, the selection of the sensors S1 and S2 for the sensor system is not limited to the above-mentioned examples. Overall, the sensor system can comprise at least one optical sensor, i.e., for example, a 2D camera, a 3D camera, a stereo camera and/or a multispectral camera, a laser sensor, a LiDAR sensor, an acoustic sensor, such as an ultrasonic sensor, and/or a radar sensor, both for determining and for verifying the target cutting plane.

It is advantageous in this respect if the sensor systems S1 and S2 comprise at least one contactless sensor, and in particular only contactless sensors, for determining the vegetation stand a, b and c of the field. Such contactless sensors allow a more comprehensive mapping of the vegetation stand a, b and c and are generally less susceptible to wear. To verify the determined target cutting plane E2, it can, however, by all means be useful to use a contact sensor, which is usually relatively inexpensive, for a mechanical sensing.

In addition to the target cutting plane E2, the evaluation unit can preferably further be configured to determine the upper edge E1 of the entire vegetation stand a, b and c that lies above the target cutting plane E2, the upper edge E3 of a weed stand c in the stem region of the crop stand b and/or the ground plane E4. This information can be used for a further evaluation or analysis of the vegetation stand a, b and c, for an even more precise determination of the target cutting plane E2 and/or for a control of a control unit for setting a cutting plane of the cutting system to the target cutting plane E2.

In the latter case, the evaluation unit can, for example, be configured to determine the target cutting plane E2 via a positive height with respect to the ground plane E4 or via a negative height with respect to the upper edge E1 of the entire vegetation stand a, b and c. The height of the cutting plane of the cutting system is then set to the determined target cutting plane E2 using the corresponding height value relative to the ground plane E4 or to the upper edge E1 of the entire vegetation stand a, b and c.

The determination of the ground plane E4 and/or the upper edge E1 of the entire vegetation stand a, b and c can in this respect take place either in the conventional way by mechanical contact sensors or via contactless sensors.

To output a signal that indicates the position of the determined target cutting plane e2, the evaluation unit is preferably coupled or at least can be coupled to an output unit.

Such an output unit can, for example, comprise an optical display, such as a screen or an LED display, for informing a user of the cutting system about the position of the determined target cutting plane E2. Alternatively or additionally, the output unit can also be configured to be coupled directly to a control unit of the cutting system in order to directly set the cutting plane of the cutting system to the determined target cutting plane E2. This direct control signal can preferably be overwritten or modified by the manual input of a user of the cutting system in order, if required, to be able to perform a manual optimization of the cutting plane of the cutting system.

A cutting system according to the disclosure is characterized by a cutting unit for trimming the vegetation of a field, a control unit for setting a cutting plane of the cutting system and a height guide according to the disclosure for determining the target cutting plane E2. Since the basic design of corresponding cutting systems is well known, the structural and functional design of such apparatus will not be discussed further here.

Finally, the method according to the disclosure for the height guidance of a corresponding cutting system will also be discussed. In particular, the method can be carried out using the above-described cutting system comprising a height guide according to the disclosure.

After the determination of a vegetation stand a, b and c of a field by a corresponding sensor system S1 and S2, the analysis of the determined vegetation stand a, b and c takes place by a corresponding evaluation unit and the automatic determination of the respective target cutting plane E2 takes place. Finally, the cutting plane of the cutting system is set to the determined target cutting plane E2.

Thus, it is possible for the cutting system to cut off the weed overhang a of the field, which projects over the upper edge E2 of the crop stand b, in a reliable and accurate manner and to collect it, if necessary.

In this respect, the determination of the vegetation stand a, b and c, which is performed to determine the target cutting plane E2, preferably takes place substantially, in particular completely, in a contactless manner. In other words, the correspondingly used sensor system S1 and S2 substantially or only includes contactless sensors that determine the vegetation stand a, b and c. However, this does not preclude mechanical contact sensors from being used for verifying the determined target cutting plane E2 or for collecting other information not provided for determining the target cutting plane E2.

As already indicated above, in addition to the determination of the target cutting plane E2, the upper edge E1 of the entire vegetation stand a, b and c disposed above it, an upper edge E3 of a weed stand c disposed below it in the stem region of the crop stand b and/or the ground plane E4 can also be determined. Corresponding information can then in particular be considered in the final setting of the cutting plane of the cutting system to the target cutting plane E2.

For example, both the ground plane E4 and the upper edge E1 of the entire vegetation stand a, b and c can act as a suitable reference point for the setting of the cutting plane to the target cutting plane E2.

Finally, it should be noted that the terms used here are always to be understood against the background of the technical environment of the present disclosure. Against the background of field hygiene, for example, the phrasing “determination of the vegetation stand a, b and c of a field” should not be understood to mean that the entire field must first be scanned in order to finally determine the target cutting plane E2. Rather, this phrasing should be understood to mean that the vegetation stand a, b and c in a specific region in front of the respective cutting system is continuously determined and analyzed while the cutting system moves across the field. The setting of the cutting plane to the target cutting plane E2 in this respect takes place in a continuous process.

Against this background, the terms “target cutting plane E2” and “cutting plane” are not to be considered in an absolute mathematical understanding of the term “plane” as an infinitely extended flat surface. Rather, these terms are to be understood as more abstract or generalized descriptions for a “target cutting height” or “cutting height” with respect to the “ground plane E4”. In this respect, the “target cutting plane E2” or the “cutting plane” can also be inclined with respect to the “ground plane” so that the term “height” would be too narrow. In this respect, the term “ground plane E4” should naturally also be understood broadly since the ground of fields is never a plane in the mathematical sense.

In this respect, the term (total) vegetation stand a, b and c used should indicate that it includes both the crop stand b and the weed stand c and a. Crop plants N are in this respect considered as actively sown plants that were originally intended for harvesting. Weeds U1 to U5 are considered as all those plants which were not actively sown and which were originally intended for harvesting.

1. A height guide for a cutting system for field hygiene, the height guide comprising:
a sensor system configured to determine a vegetation stand of a field; and
an evaluation unit coupled to the sensor system,
the evaluation unit configured to analyze the vegetation stand and further configured to determine a target cutting plane that lies at the a level of an upper edge of a crop stand, the upper edge of a crop stand lying below an upper edge of an entirety of the vegetation stand.

2. The height guide according to claim 1, wherein
the sensor system comprises at least one contactless sensor.

3. The height guide according to claim 2, wherein
the sensor system only comprises contactless sensors.

4. The height guide according to claim 1, wherein
the sensor system comprises at least one of the following sensors: an optical sensor, a laser sensor, a LiDAR sensor, an acoustic sensor, or a radar sensor.

5. The height guide according to claim 1, wherein
the sensor system comprises at least two sensors and the evaluation unit is configured to determine or to verify the target cutting plane based on the signals of at least two of these sensors.

6. The height guide according to claim 1, wherein
the evaluation unit is configured to determine the target cutting plane using a first set of sensors and to verify the target cutting plane using a second set of sensors.

7. The height guide according to claim 1, wherein
the sensor system has a 3D stereo camera and the evaluation unit is configured to determine the target cutting plane by an evaluation of a 3D point cloud obtained above the target cutting plane.

8. The height guide according to claim 1, wherein
the sensor system comprises an ultrasonic or radar sensor and the evaluation unit is configured to verify an already determined target cutting plane based on an output of the ultrasonic or radar sensor.

9. The height guide according to claim 1, wherein
the evaluation unit is configured to determine the upper edge of the entirety of the vegetation stand or an upper edge of a weed stand in a stem region of the crop stand or a ground plane.

10. The height guide according to claim 9, wherein
the evaluation unit is configured to determine the target cutting plane via a positive height with respect to the ground plane or via a negative height with respect to the upper edge of the entirety of the vegetation stand.

11. The height guide according to claim 1, wherein
the evaluation unit is coupled or configured to be coupled to at least one output unit configured to output a signal indicating a position of the target cutting plane.

12. The height guide according to claim 11, wherein
the output unit comprises an optical display configured to inform a user of the cutting system of the position of the target cutting plane.

13. The height guide according to claim 11, wherein
the output unit is configured to be coupled to a control unit of the cutting system and to output a control signal to the control unit, the control signal setting a cutting plane of the cutting system in accordance with the target cutting plane.

14. A cutting system for field hygiene, comprising:
a cutting unit configured to trim vegetation of a field;
a control unit configured to set a cutting plane of the cutting system; and
a height guide comprising a sensor system configured to determine a vegetation stand of a field, and an evaluation unit coupled to the sensor system, the evaluation unit configured to analyze the vegetation stand and further configured to determine the target cutting plane lying at a level of an upper edge of a crop stand, the upper edge of a crop stand lying below an upper edge of an entirety of the vegetation stand.

15. A method for height guidance of a cutting system for field hygiene, the method comprising:
determining a vegetation stand of a field by a sensor system;
analyzing the vegetation stand by an evaluation unit,
automatically determining a target cutting plane that lies at a level of an upper edge of a crop stand, the upper edge of the crop stand lying below an upper edge of an entirety of entire vegetation stand; and
setting a cutting plane of the cutting system to the target cutting plane.

16. The method according to claim 15, wherein
the determining the vegetation stand takes place substantially in a contactless manner.

17. The method according to claim 15, wherein
the upper edge of the entirety of the vegetation stand, an upper edge of a weed stand in a stem region of the crop stand or a ground plane are also determined.

18. The method according to claim 17, wherein
the target cutting plane is determined via a positive height with respect to the ground plane or via a negative height with respect to the upper edge of the entirety of the vegetation stand.

19. The height guide according to claim 1, wherein the height guide is configured for a weed cutter or a weed seed collection unit.

20. The height guide according to claim 6, wherein the second set of sensors comprises sensors that are not also assigned to the first set of sensors.

21. The method according to claim 17, wherein the upper edge of the entirety of the vegetation stand, an upper edge of a weed stand in a stem region of the crop stand or the ground plane are also considered when setting the cutting plane.
